(19) United States
(12) Patent Application Publication
(10) Pub. No.: US 2009/0062015 A1
(43) Pub. Date: Mar. 5, 2009

(54) GAME PLAYING DEVICE WITH NETWORKED PLAYBACK CAPABILITY

(76) Inventors: Ari Birger, Palo Alto, CA (US); Ilya V. Netchitailo, Livermore, CA (US)

Correspondence Address: CENTURY IP GROUP, INC. [Main], P.O. BOX 7333, NEWPORT BEACH, CA, 92658-7333, US

(21) Appl. No.: 12/203,031

(22) Filed: Sep. 2, 2008

Related U.S. Application Data
(60) Provisional application No. 60/970,028, filed on Sep. 5, 2007.

(51) Int. Cl. A63F 9/24; G06F 19/00

(52) U.S. Cl. 463/42; 463/43; 463/16

(57) ABSTRACT

A game playing device and a computer readable medium with a set of instructions for playing a game encoded thereon and a set of instructions encoded thereon such that the game playing device is recognized as a controllable playback device in a networked environment.

### CROSS-REFERENCE TO RELATED APPLICATION

Pursuant to 35 USC 119, this Application claims the benefit of filing date and right of priority to U.S. Provisional Patent Application No. 60/970,028 filed on Sep. 5, 2007, and U.S. Non-Provisional patent application Ser. No. 11/608,190 filed on Dec. 7, 2007. The contents of the above two Applications are incorporated herein in their entirety.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present disclosure relates generally to a game playing device and a computer readable medium with a set of instructions for playing a game encoded thereon and a set of instructions encoded thereon such that the game playing device can also work as a controllable playback device in a networked environment.

### BACKGROUND

Game playing devices such as game consoles are common. Many such devices include the ability to play back media. For example, the Sony PS3 includes a DVD reader that can read “Blue-Ray” high definition digital video disks (DVDs) so that a user can play back movies, etc., on the game console. The Microsoft XBOX360 also includes the ability to play back media.

Recently homes have become increasingly networked, and media for playback has become increasingly digital. There has been effort recently in providing users the ability to payback media within a networked environment. Recently, computer systems that include a large amount of storage and that are designed for home entertainment use have been appearing on the market. Microsoft has an operating system called Microsoft Media Center Edition, which includes specification for playback and other devices and which includes media content support and Microsoft Windows.

Game playing devices are increasingly networked. It is desired to use common game playing devices such as Microsoft XBOX360, or Sony PS2, or Sony PS3, etc., as controllable playback devices for media over a network. For example, it is desired to have such a game playing device recognized as a controllable playback device, also called a media player under the Universal Plug and Play standard called UPnP. Is also is desired to have such a game playing device to be recognized as a controllable playback device by remote control units, e.g., remote control units that operate as a control point for a plurality of devices under the UPnP standard.

UPnP is becoming more and more used for playback of media content in a network. See, for example, the UPnP Forum at www.upnp.org. UPnP describes an audiovisual architecture that includes interaction between UPnP control points and UPnP AV devices. The architecture is independent of any particular device type, content format, and transfer protocol, and supports a variety of devices such as TVs, VCRs, CD/DVD players/jukeboxes, set-top boxes, stereos systems, MP3 players, still-image cameras, camcorders, electronic picture frames (EPFs), network storage devices, and personal computers. The UPnP AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET/PUT/POST, RTP, TCP/IP sockets, UDP, etc.).

A remote control device may provide an intuitive interface for controlling a home entertainment network that includes one or more media source devices, one or more media storage and/or playback devices, one of which is a media server maintaining media content items in electronic form, and one or more media output devices. The term “controlling” is used to mean routing the media path from one or more input or playback/storage devices to one or more output devices, and selecting one or more items for playback.

Hardware manufacturers such a Microsoft, Sony, etc., design their game consoles to play their particular media formats. In addition, in the case the game controllable playback device is networkable, the game device may connect to other game devices over the network or the game device may accept media over a network. For example, the Microsoft XBOX360 works as what is called a media extender device under the Microsoft Media Center Edition architecture. We found, however, that the manufacturers restrict the type of media playable, e.g., to their own type of media, e.g., Windows Media in the case of Microsoft, Real Media in that case of Real Networks, etc. We further have found that such devices, although connectable to a network, do not recognize control commands such as those conforming to UPnP.

Therefore, it is desired to convert a game playing device into a device that is recognized as a media controllable playback device in a network.

### SUMMARY

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In one embodiment, an apparatus comprising a networkable game-playing device, e.g., a game console such as an XBOX360, a Sony PS2, a Sony PS3, a Nintendo game unit, or the like, that includes one or more processors, a memory, a media reader, one or more network interfaces operative to couple the game-playing device to a network, and a removable computer-readable medium is provided. The media reader is operable to read the contents of the removable computer-readable medium when the removable computer-readable medium is inserted into the media reader. The removable computer-readable medium in combination with the game-playing device is operative when the removable medium is in the game-playing device to implement a game such that a user can play the game including interacting with the game-playing device.

Instructions encoded on the removable computer-readable medium when executed cause the game-playing device to be recognizable as a controllable playback device via the network, including responding to networked playback commands received via the network such that the game-playing device further operates as a controllable playback device operative to play back digital media. Operating the networkable game-playing device as a controllable playback device does not require a user to load playback software into the game-playing device other than inserting the removable medium into the networkable game-playing device.

In one embodiment, a computer-readable medium with a first set of instructions encoded thereon and with a second set of instructions coded thereon is provided. The computer-readable medium is a removable computer-readable medium that can be coupled to a networkable game-playing device that includes one or more processors, a memory, at least one network interface operative to couple the game-playing device to a network, and a media reader in which the removable computer-readable medium is insertable and which is operable to read the first set of instructions when the computer-readable medium is inserted in the media reader.

The first set of instructions when executed by the one or more processors cause the game-playing device to be recognizable as a controllable playback device via the network, including responding to networked playback commands received via the network such that the game-playing device further operates as a controllable playback device operative to play back digital media. The second set of instructions when executed by the one or more processors cause the game-playing device to implement a game such that a user can play the game including interacting with the game-playing device, such that operating the networkable game-playing device as a controllable playback device does not require a user to load playback software into the game-playing device other then inserting the removable medium into the networkable game-playing device.

In one embodiment, a method for providing a playing a game on a game playing device is provided. The method comprises reading program instructions of a first set of instructions from a removable medium with the first set of instructions encoded thereon and with a second set of instructions coded thereon. The reading is performed via a media reader in a networkable game-playing device that includes one or more processors, a memory, one or more network interfaces operative to couple the game-playing device to a network, and the media reader in which the removable computer-readable medium is insertable.

The media reader is operable to read the first and the second set of instructions, and the second set of instructions when executed by the one or more processors causes the game-playing device to implement a game such that a user can play the game including interacting with the game-playing device. The method also comprises executing the read instructions on one or more of the processors of the game-playing device to cause the game-playing device to be recognizable as a controllable playback device via the network.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1A is an illustrative view showing a game playing device, in accordance with one embodiment.

FIG. 1B is a block diagram showing an electric configuration of the game playing device shown in FIG. 1A, in accordance with one embodiment.

FIG. 2 shows an example network of networks in a home containing several audiovisual (AV) devices that are connected by the network of networks and that includes an embodiment of the present invention, in accordance with once embodiment.

FIG. 3 shows a simple representation of a conventional UPnP AV architecture, accordance with one embodiment.

FIG. 4 shows a simple representation of an UPnP AV architecture, in accordance with one embodiment.

FIG. 5 is a flow diagram of a method for providing a game-playing device with networked playback capability, in accordance with one embodiment.

Features, elements, and aspects of the invention that are referenced by the same numerals in different figures represent the same, equivalent, or similar features, elements, or aspects, in accordance with one or more embodiments.

### DESCRIPTION OF EXAMPLE EMBODIMENTS

The present disclosure is directed to systems and methods for providing a game-playing device with networked playback capability.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

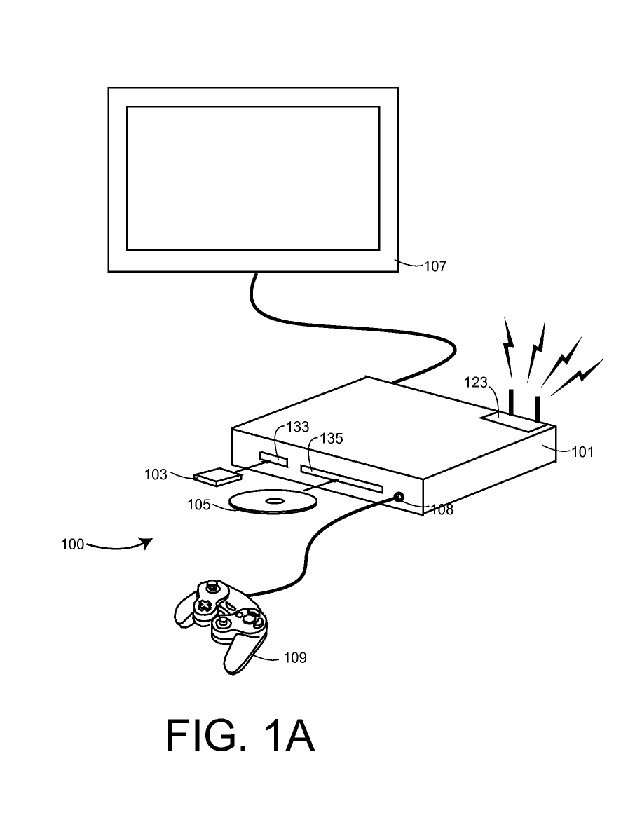

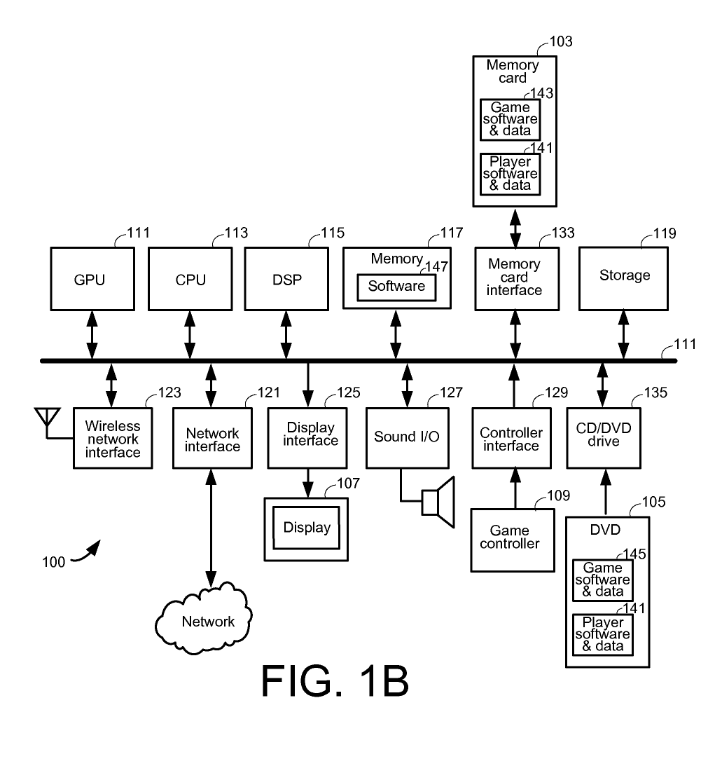

FIG. 1A is an illustrative view showing a game playing system that includes an embodiment of the present invention. The game playing system includes a game playing apparatus 100 that includes a housing 101 with an optical disk drive 135. An optical disk 105 such as a CD or DVD is one example of a computer-readable medium on which a set of instructions for playing a game is encoded. The housing includes a set of connectors of which connector is one example. Connector 108 is for connecting a game controller 109 to the game playing apparatus 100, in this example via a cable. In other embodiments, a connector may be wirelessly connected to the same playing apparatus. Other connectors include a USB connector, a network connector, and so forth.

In one embodiment, the game playing apparatus 100 includes a memory card interface 133, e.g., as a memory card slot into which a memory card 103 is insertable. The memory card 103 includes a solid-state memory, e.g., flash memory. A memory card 103 is another example of a computer-readable medium on which a set of instructions for playing a game is encoded.

The embodiment shown includes both an optical disk reader 135 and a memory card interface 133. In one such embodiment, the optical disk contains the set of program instructions for playing the game, and the memory cars 103 is usable for loading instructions for playing the game from the optical disk, or saving game data of the game, such as result data or progress data, and so forth. Alternate embodiments include only a memory card reader 133 or an optical disk reader 135.

One such memory interface is in the form a USB interface that has a USB connector into which a USB device with a solid state memory is insertable. The USB device with memory forms a computer-readable medium. The playing system may include a display monitor 107, shown connected to the game playing apparatus via a cable.

FIG. 1B is a simplified block diagram of the game playing device 100 shown in FIG. 1A. In one embodiment, the game playing device includes at least one processor. FIG. 1B shows three processors, a CPU 113, a graphics processing unit (GPU) 111, and a digital signal processor (DSP) 115. Alternate embodiments can have more or fewer processors of the same or different kinds, e.g. for media decoding. The game playing device further includes a memory subsystem 117 that includes program instructions shown as software 147 that when executed by one or more processors of the device 100 are operative to carry out one or more functions, e.g., for game execution or network communication.

In one embodiment the device 100 includes a storage subsystem, e.g., in the form of a hard disk for storing different programs and playable data thereon. In one embodiment, the device 100 includes a memory card interface to which a removable memory card is connectable. The removable memory card forms a computer-readable medium that has encoded thereon a first set of program instructions 141 and a second set of program instructions 143. In one embodiment, the device 100 includes an optical drive, e.g., a CD/DVD drive in which an optical disk 105 such as a CD or DVD is insertable. The optical disk forms a computer-readable medium that has encoded thereon a first set of program instructions 141 and a second set of program instructions 145.

For simplicity, one memory block 117 is shown, but those in the art will understand the program instructions shown therein may be distributed in different parts of the device 100. For example, the GPU 111 and the DSP 115 might have separate memory for their respective program instructions, and also additional data memory. Furthermore, not all of the programming instructions would be in the memory subsystem at the same time. For example, some of the program instructions may be in the storage subsystem. 119.

The game-playing device 100 includes a controller interface 129 to which a game controller 109 is connectable. The game-playing device 100 includes at least one network interface. In the embodiment shown, the game-playing device 100 includes one wireless network interface 123, e.g., an IEEE 802.11 interface, and also a wired network interface 121, e.g., an Ethernet interface. Alternate embodiments include only one network interface. Yet other alternate embodiments include more than one wireless interfaces for different wireless networks.

The game-playing device 100 includes a display interface 125 to which a display device 107 is connectable. The game-playing device 100 further includes a sound I/O device to which a sound playback device, e.g., a loudspeaker is connectable. In one embodiment, the sound I/O device also can be connected to a sound input device such as a microphone.

The first set of instructions 141 in the removable computer-readable medium, e.g., in memory card 103 or optical disk 105 when executed by the one or more processors cause the game-playing device 100 to be recognizable as a controllable playback device via the network, including responding to networked playback commands received via the network such that the game-playing device further operates as a controllable playback device operative to play back digital media,

The second set of instructions 143 in the case of the memory card 103, or 145 in the case of the optical disk 105 when executed by the one or more processors cause the game-playing device 100 to implement a game such that a user can play the game including interacting with the game-playing device,

Note that by the phrases “the first set of instructions when executed” or “the second set of instructions when executed,” those in the art will understand that the first or the second set might be combined with other program instructions to perform the stated functionality, and furthermore, that such phrases do not imply all of the first set or second set are in the removable computer-readable medium.

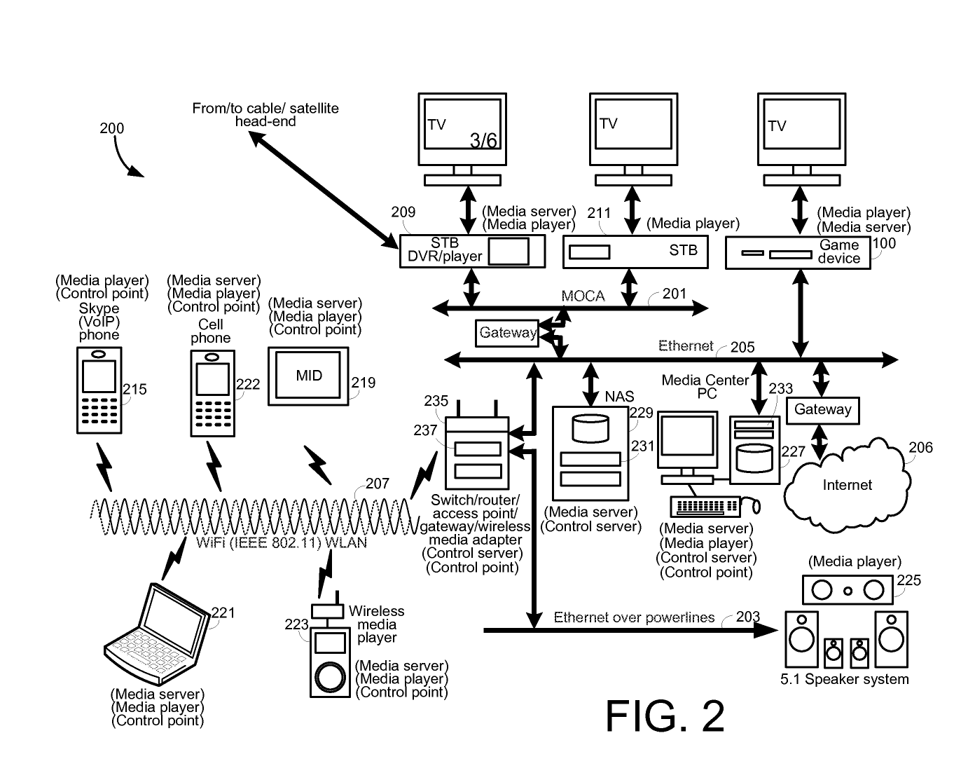

FIG. 2 shows an example network 200 of networks in a home containing several audiovisual (AV) devices—storage/retrieval/input/playback devices—that are connected by the network of networks and that include an embodiment of the present invention. Shown in parentheses are the roles some of these devices have in an AV architecture that conforms to a Universal Plug and Play (UPnP) AV architecture. Some embodiments of the present invention operate in a home network exemplified by FIG. 2.

The network of networks of FIG. 2 includes a Media over Coax (MOCA) network 201, an Ethernet over powerlines network 203, a wired local area network, e.g., an Ethernet 205, and a wireless network (wireless local area network, WLAN) 207, e.g., a Wi-Fi network that conforms to the IEEE 802.11 standard. The network 200 also includes a connection to another network, e.g., the Internet 206. Coupled to the Internet 206 may be one or more servers 227 containing one or more databases of media content.

In one embodiment, the AV devices in FIG. 2 conform to the UPnP standard, and are used to illustrate embodiments of the invention that operate with devices that conform to the UPnP standard. The role or roles of each AV device in FIG. 2 is shown in parentheses.

FIG. 2 includes a set top box (STB) and DVR combination 209 that is coupled via cable to a cable or satellite headend, and also coupled to the MOCA network 201. The STB/DVR player is capable of playback and is also a source of AV content, so it is a media server in the UPnP context. Also coupled to the MOCA network is an STB 211 that is a media player in the UPnP context and is coupled to an AV monitor for viewing AV content. The MOCA network is coupled to the Ethernet 205.

Also coupled to the network is a game playing device 100 that when combined with a removable computer-readable medium is operable to appear as a media player in the network 200. In the embodiment shown, the game-playing device 100 is coupled to the Ethernet 205, e.g., via the network interface 121.

Coupled to that Ethernet 205 is a network attached storage device (NAS) 229 wherein media content is stored. The NAS device 229 is used as a media server in the UPnP context, so it can be set up by a control point to send content for playback to a playback device in the out-of-band channel. In one embodiment, the NAS device 229 includes logic 231, e.g., software, e.g., in memory that when executed implements an embodiment of what we call a “control server” as described in more detail below. The control server in one embodiment communicates with one or more remote control devices that provide a user interface for controlling via the control point. The control point and control server implement one or more features of the invention. See below for more details.

Also coupled to the Ethernet 205 is a personal computer (PC) 227 that is set up in the UPnP context to be a media server, a media store configurable to send AV media (“AV content”) to another media server, a media player to play back AV content, and a control point. In one embodiment, the PC is an Intel based PC (Intel Corporation, Santa Clara, Calif.) that uses the Microsoft Media Center Edition (XP or Vista) as its operating system. In an alternate embodiment, the PC 227 is an Apple Mac desktop computer (Apple Computer Inc. Cupertino, Calif.). In an alternate embodiment to the one in which the NAS device 229 includes logic operable to implement a control server and control point, the PC includes logic 233, e.g., software, e.g., in memory and storage that when executed on a processor of the PC 227, implements an embodiment of a control server and a control point connected to the control server as described in more detail below.

The Ethernet 205 is also coupled to the Internet 206, and also to the Ethernet over powerlines network 203. In FIG. 2, there is a 5.1 speaker system 225 coupled to that Ethernet over powerlines network 203 that acts as a media player in the UPnP context.

Also coupled to the Ethernet is a wireless network access point 235 for the wireless network 207. In one embodiment, the wireless network access point also acts as a switch or router, and also as a gateway for other networks. In one embodiment, the wireless media adapter 235 includes a processor and a memory. In an alternate embodiment to the one in which the NAS device 229 or the PC 227 includes logic operable to implement a control server, the wireless media adapter 235 includes logic 237, e.g., software, e.g., in the memory that when executed on the processor of the wireless media adapter 235, implements an embodiment of a control server as described in more detail below.

Several devices are shown coupled to the wireless network 207. A laptop PC 221 and a wireless portable media player 223, e.g., a wireless MP3 and video player 223, are operable to be coupled to the WLAN. Each of these can have the roles of a media server, a media player, and/or a control point in the UPnP context. In an alternate embodiment, the laptop PC 221 can have the role of control server.

Also connectable to the wireless network 207 are some portable devices that each can be used as a remote control that includes one or more features of the present invention. For example, in an embodiment in which the NAS device 229 also acts as what we call a control server, or in an embodiment in which the PC 227 also acts as what we call a control server as well as a control point coupled to the control server, each of these portable devices may be operable to communicate with the control server to provide remote control functionality to one or more of the media player devices and/or locate content and set up playback thereof. In alternate embodiment, each such portable device is a remote control that includes one or more features of the present invention.

One portable device is primarily a voice-over-IP (VoIP) phone 215, such as a Skype phone (Skype, an eBay company, Luxembourg), and includes a processing system and software to implement remote control functions including one or more features of the present invention. In one embodiment, the VoIP phone 215 also includes components operable to store and playback media (content), so in the context of UpnP, can have the role of a control point and a media player. As described further below, in some embodiments, some remote control features are in conjunction with services remote to the device, e.g., software running on the media center PC 227 implementing what is called a control server that is coupled to a control point also implemented on the media center PC 227.

Another device in the example network 200 connectable to the wireless network is a mobile cellular phone that includes a wireless network interface to connect to the wireless network 207, and that includes a processing system and software to implement remote control functions including one or more features of the present invention. In one embodiment, the cell phone 222 also includes components that are operable to store and playback content (media), so in the context of UpnP, the cell phone 222 can have the role of a control point, a media server and a media player.

As described further below, in some embodiments, some remote control features are in conjunction with services remote to the device, e.g., software running on the media center PC 227 implementing what is called a control server that is coupled to a control point also implemented on the media center PC 227. Similarly, included in the network 200 is a mobile internet device (MID), e.g., hand-held computer 219, e.g., one operating under a Linux operating system. The handheld computer 219 includes a wireless network interface to connect to the wireless network 207, and that includes a processing system and software to implement remote control functions including one or more features of the present invention.

In one embodiment, the handheld computer 219 also includes components that are operable to store and playback media content, so in the context of UpnP, the handheld computer 219 can have the role of a control point, a media server and a media player. As described further below, in some embodiments, some remote control features are in conjunction with services remote to the device, e.g., software running on the media center PC 227 implementing what is called a control server that is coupled to a control point also implemented on the media center PC 227.

While in one embodiment, the removable computer-readable medium includes programming instructions that when executed by one or more processors of the game-playing device cause the game playing device to appear as a controllable playback device, e.g., a UPnP playback device, some game-playing device are able to store digital content, e.g., in the storage subsystem 119, or, for example, on a DVD that is inserted into the optical disk reader. In some embodiments, the removable computer-readable medium includes programming instructions that when executed by one or more processors of the game-playing device cause such a game playing device that is operative as a source of AV content to appear as a controllable media server, e.g., in the UPnP context.

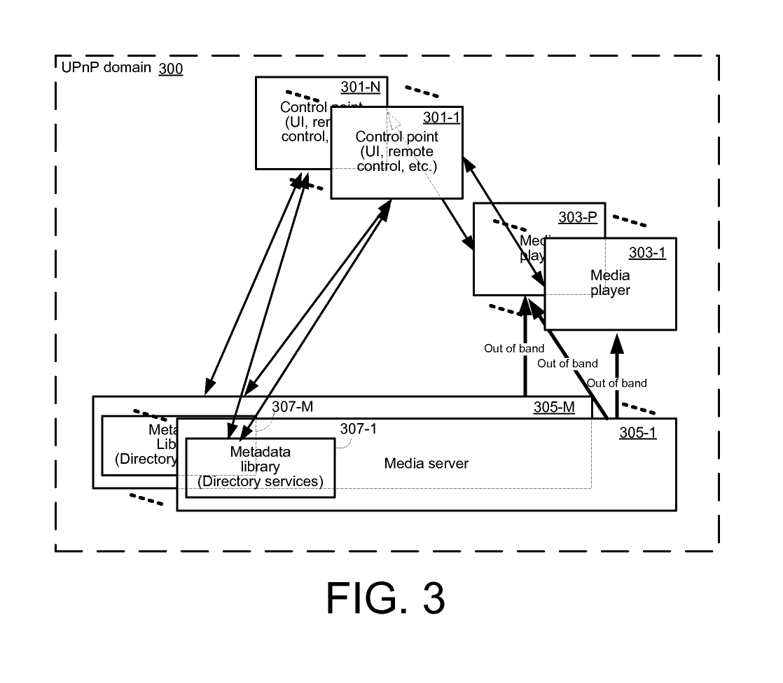

Some embodiments of the invention operate with devices that conform to the Universal Plug and Play standard (UPnP). FIG. 3 shows a conventional AV architecture according to the UPnP standard. The example network shown in FIG. 2, for example, can operate under this arrangement. Note “control server” as shown in FIG. 2 is not a component of a prior art UPnP AV architecture.

According to conventional UPnP AV architecture, three distinct entities are involved: 1) a control point, 2) a source of media content, called a “media server”, and a sink for the content, called a “media renderer,” “media player,” or “media playback device” herein. While in this disclosure, all three entities are often described as if they were independent devices on the network, and such a configuration is actually possible, e.g., a VCR (the media server), a control device, e.g., coupled to a remote control (the control point), and a TV (the media player), those in the art will understand that the UPnP AV architecture supports arbitrary combinations of these entities within a single physical device.

As described above, one embodiment of the present invention includes a removable computer-readable medium that includes program instructions. When the computer-readable medium is inserted in an embodiment of a game-playing device that is connectable to a network, the program instructions when executed by one or more processors of the game-playing device cause the game-playing device to appear as a controllable playback device in the network. In another embodiment in which the game playing device also can source digital content, the program instructions when executed by one or more processors of the game-playing device also cause the game-playing device to appear as a controllable media server in the network.

In one embodiment, such a playback device is a UPnP playback device. Furthermore, such a media server is a UPnP media server. FIG. 3 shows a conventions UPnP domain for AV that includes a number denoted N of one or more control points 301-1, . . . ,301-N, a number denoted P of one or more media players 303-1, . . . , 303-P, and a number, denoted M of one or more media servers 305-1, . . . , 305-M, respectively. The game-playing device is one of the media players, and when able to source media, the game playing device also is one of the media servers.

The individual media servers and the media players do not directly interact with one another. Rather, each control point interacts with one or more media servers and/or one or more media players. For playback, for example, a control point sets up a media server and a media player using UPnP to initialize and configure both devices so that desired content is transferred from the media server to the media player, or in another example, from one media server to another media player. The content is transferred from one device to the other using an “out-of-band” transfer protocol; the control point is not directly involved in the actual transfer of the content. Neither the media server nor the media player invokes any UPnP actions to the control point. However, if needed, the media server and/or media player may send event notifications to the control point in order to inform the control point of a change in the media server's and/or media player's internal state.

For more details on UPnP AV transfers, see for example, “UPnP AV Architecture:0.83, For UPnP™ Version 1.0” from the UPnP Forum, www.upnp.org, dated Jun. 12, 2002. Devices may have their own control points. For example, it is common for playback devices to have a dedicated control point, e.g., a control point sold with, even incorporated with the playback device, and dedicated to controlling the playback device.

Each media server is used to locate content that is available via the network, e.g., the example network shown in FIG. 2. Media servers include a wide variety of devices including VCRs, DVD players, satellite/cable receivers, TV tuners, radio tuners, CD players, audio tape players, MP3 players, PCs, etc. A media server's primary purpose is to allow control points to enumerate, (e.g., browse or search for) content items that are available for the user to play back. Each media server contains a ContentDirectory service, a ConnectionManager service, and an optional AVTransport service, depending on the supported transfer protocols.

Some media servers are capable of transferring multiple content items at the same time, e.g. a hard-disk-based audio jukebox may be able to simultaneously stream multiple audio files to the network. In order to support this type of media server, the ConnectionManager assigns a unique identifier, called a ConnectionID to each “connection,” e.g., each stream that is made. This ConnectionID allows other control points, e.g., the control point according to an embodiment of the present invention, to obtain information about active connections of the media server.

Each media server 305-1, . . . 305-M includes a service called a ContentDirectory service, or simply “directory service” herein, that provides a set of actions that allow a control point to enumerate the content that the media server can provide to the network. The primary action of directory service is called Browse( ), another is called Search( ) herein and allows a control point to obtain or search for detailed information about each content item that the media server can provide. This information is called “metadata” herein. Each media server 305-1, . . . 305-M is thus shown to include a respective metadata library 307-1, . . . 307-M that is used to provide the directory service for the respective media server.

While usually metadata library is collated on the same device as the content itself, this need not be the case, as long as there is some link, e.g., pointer from one to the other. Metadata includes properties such as the content type, name, artist, date created, size, etc. Additionally, the metadata identifies the transfer protocols and data formats that are supported by the media server for that particular content item. The control point uses this information, for example, to determine if a given media player is capable of rendering that content in its available format.

Each control point is responsible for discovering AV devices (media servers and media players) in the network using UPnP's discovery mechanism, media servers and media players in the home network are discovered. Each control point also is responsible for locating desired content using the Directory services Browse( ) or Search( ) actions. The information returned by Browse( )/Search( ) includes the transfer protocols and data formats that the media server supports to transfer the content to the home network. Each control point also is responsible for obtaining each media player's supported protocols/formats.

Those in the art will understand that in a network environment such as shown in FIG. 3 that includes a plurality of control points, i.e., N>1, one or more media servers, so M≧1, and a plurality of media players, i.e., N>1, in order for each control point to properly function, e.g., be able to control playback of media content on each playback device, each control point needs to discover each device in the network, and further, maintain the state and capabilities of each device in the network. Errors can occur when the state known to the different control devices is not the same.

Furthermore, in some networks, it takes some time for the different control points to fully discover devices in the network and to become synchronized to each other. Furthermore, in order for a control point to maintain information on each device, the control points possibly needs to be able to operate a complex set of user interfaces for the various devices, and maintain information on, for example, the content in each media server. Therefore, a typical control point would need to have processing power and memory or other storage sufficient to carry out these functions efficiently.

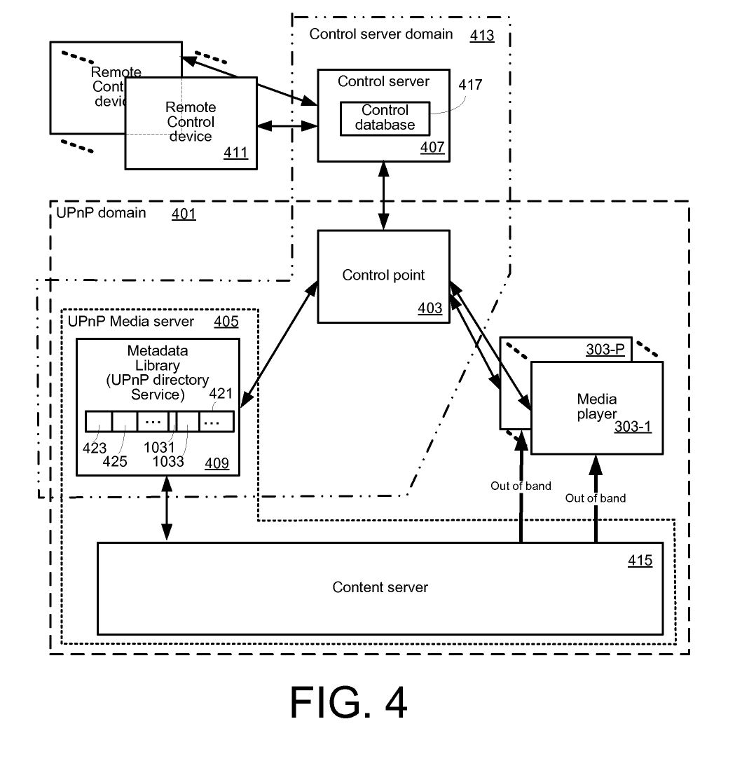

FIG. 4 shows a simple block diagram of UPnP network arrangement 401 that includes one and only one control point 403 in the UPnP domain. The control point includes the ability to discover devices and obtain state information from each device. One such device is the game-playing device embodiment 100 after the removable medium is inserted in the device 100 and when the device is coupled to the network, in which case the device in one embodiment is discoverable as a media player, and further, in the case the game-playing device embodiment 100 is operative to source digital content over the network, one device embodiment 100 also is discoverable as a media server.

However, because there is one and only one control point for all devices on the network, there is no situation where different control points maintain different states of information. Coupled to the control point is a control server 407 that maintains information on different devices, such as the state of the network, e.g., each device on the network, on the different controls required for each device, user interfaces, and so forth. The control server 407 is typically but not necessarily co-located with the control point 403 such that the combination of the control point 403 and the control server 407 is in the form of hardware, software, and data in a processing system. In the example network shown in FIG. 2, the control server can be in such devices as the media center PC 177, the network attached storage 229, or the wireless media adapter 235.

One function of the control server is to establish connection with one or more remote control devices 411. In one embodiment, at least one remote control device 411 is coupled to the control server 407 via an IEEE 802.11 wireless network, e.g., the network 207 in the example arrangement of FIG. 2, in which case the remote control devices in communication with the control server 407 are one or more of devices 219, 222, and/or 223. The remote control device in one embodiment has the general architecture described in U.S. Patent Publication U.S. Published Patent Application Publication No. US 20070136778 of U.S. application Ser. No. 11/608,190 filed 7 Dec. 2007 to inventors Birger et al., the contents of which are incorporated herein by reference.

For each particular remote control device, the combination of the particular remote controller, corresponding parts of the control server 407, and the control point 403 perform functions that previously might have been performed by a particular one of the plurality of control points 301-1, . . . 301-N in the system shown in FIG. 3. However, in one embodiment, each remote controller can be a “lightweight” device with relatively little local memory and with relatively little computational power.

The control server 407 maintains information on how each device is controlled, including how each playback device is controlled, user interface elements for the remote controllers, and so forth. In one embodiment, the control server includes a database of information, called the control database 417 herein. The control database 417 maintains information on the network, including the devices at each location, the capability of each device, and so forth, and further information on each remote control device 411 with which the control server is in communication.

The control server 407 and the one and only control point form a control server domain 413 for the UPnP domain 401. In one embodiment, the control server and control point operate in a processing system such as described in U.S. Patent Publication U.S. Published Patent Application Publication No. US 20070136778 of U.S. application Ser. No. 11/608,190 filed 7 Dec. 2007 to inventors Birger et al., the contents of which are incorporated herein by reference, as software executing on the processor of the processing system.

Thus, as stated above, because there is only one control point, only one device needs to maintain state of the overall UPnP network. There is thus less chance of error than with the architecture shown in FIG. 3. Those who are skilled in the art will understand that the logic, e.g. software, of the one control point may be embodied on one or more tangible processing systems coupled to the network, e.g. computers in one embodiment, and may include a standby backup control point logic or a load balancing control point logic in alternate embodiments that appear as one control point in the control server domain 413.

Furthermore, the architecture shown in FIG. 4 is compatible with standard UPnP. The media server and media playback devices typically would not need to be modified to work with this architecture, except of course, in the case of a device that for the architecture of FIG. 3 came with a dedicated control point, that control point's function would be carried out by the control server 407 in combination with a remote control unit 411 and the control point 403 in the system shown in FIG. 4.

Only one media server is shown in FIG. 4. In this description, it will usually be assumed that there is only one metadata library, and in alternate embodiments, there is a plurality of metadata libraries. Those in the art will understand how to modify the description herein for the case of a plurality of metadata libraries. The directory service uses a metadata library 409 that includes the metadata on one or more content items. The metadata library can be on the same or a separate device from where the content server's content items are stored. FIG. 4 shows the content items in a content server 415. The content server 415 and metadata library 409 together form a media server 405 in the UPnP context.

In one embodiment, the control server 407 is coupled to the metadata library of each media server 405. In one embodiment, the metadata library 409 is part of the control server domain 413 and operates on the same device, e.g., server computer as the control server 407 and control point 403. Those in the art will understand that in alternate embodiments, the metadata library is on a different device, and the coupling between the control server 407 and the metadata library 409 is via a network.

One embodiment of the control point includes an API for the control server to enable the control point to accept commands from the control server, provide the status of the network ad of one or more devices on the network to the control server. In one embodiment, the control server and control database are implemented as provided in U.S. Patent Application U.S. Pat. No. 7,127,305 to inventor Palmon titled METHOD AND APPARATUS FOR UNIFIED CONTROL OF MULTIPLE DEVICES. The contents of U.S. Pat. No. 7,127,305 are incorporated herein by reference.

One implementation of the control point 403 and the control server 407 is in the form of logic, e.g., software, possible in combination with hardware. The logic is embodied on one or more tangible computer readable media. The logic includes control point logic, that, when executed on one or more processors of a processing system is operable to implementing the control point 403. The logic also includes control server logic, that, when executed on one or more processors of a processing system is operable to implementing the control server 407. When executed in a processing system that is coupled to a network, the control point logic is operable to communicate with one or more media players—players 303-1 to 303-P in the case of P media players—and/or with one or more media servers, e.g., server 405.

Each media player and media server is coupled to the network and conforms to a standard that uses a standard communication control protocol. In the example described herein, the standard is the UPnP standard, and the communication protocol is the UPnP protocol. The control point logic is further operable when executed to control any one of media players and any one of the media servers using the standard communication control protocol, e.g., UPnP. The control protocol, e.g., UPnP is able to cause playback at a selected media player of a selected item of content of a selected media server. Playback includes transfer of the data of the selected item of content from the selected media server to the selected media player, e.g., using an out-of-band protocol.

The control server logic is operable when executed on a processing system coupled to the network to implement a control server, e.g., control server 407 coupled to the control point. In particular, the control server logic is operable when executed to access a control database, e.g., database 417 that includes information for controlling one or more of the media players and media servers. The control server logic is further operable when executed to receive data from one or more remote control devices, e.g., devices 411, and to interpret data received from a selected remote control device and cause the control point module to control any one of media players and/or any one of the media servers according to the received data.

In one version, the control server logic is further operable when executed to send data to the selected remote control device and further able to interpret data from the control point module and send corresponding data to the selected remote control device.

From the user point of view, operating a remote control device is as described in U.S. Patent Publication U.S. Published Patent Application Publication No. US 20070136778 in the section titled “An Example of Usage.” The content search and browse function is provided by the UPnP control point 403 interacting with the media server 405, and the control server 407/remote control device 411 communicating with the control point 403.

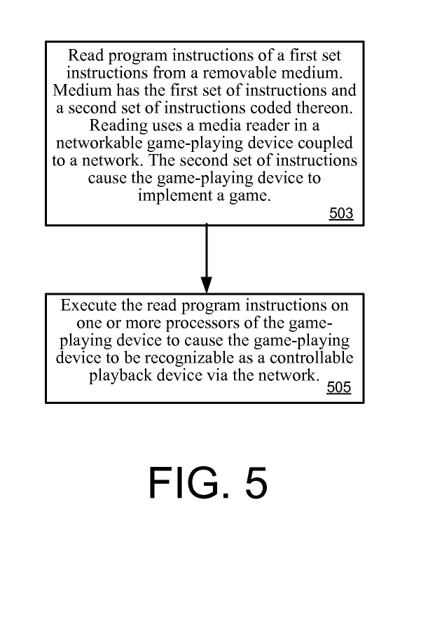

FIG. 5 shows a simplified flowchart of a method for providing a game-playing device with networked playback capability. The method includes in 503 reading program instructions of a first set instructions from a removable medium with the first set of instructions encoded thereon and with a second set of instructions coded thereon, the receiving in a networkable game-playing device that includes one or more processors, a memory, a network interface operative to couple the game-playing device to a network, and a media reader in which the removable computer-readable medium is insertable and which is operable to read the first set of instructions.

The method further includes in 505 executing the instructions on one or more of the processors of the game-playing device to cause the game-playing device to be recognizable as a controllable playback device via the network. The second set of instructions when executed by the one or more processors cause the game-playing device to implement a game such that a user can play the game including interacting with the game-playing device.

One embodiment further comprises receiving one or more playback commands via the network, and playing back content according to the one or more playback commands. In one embodiment, the method causes the game-playing device to be recognizable as a controllable playback device in an UPnP domain. One such embodiment comprises receiving one or more playback commands from an UPnP control point via the network, and playing back content according to the one or more playback commands.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., steps is implied, unless specifically stated.

It will be understood that the steps of methods discussed are performed in one embodiment by an appropriate processor (or processors) of a processing (i.e., computer) system executing instructions stored in storage. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the DESCRIPTION OF EXAMPLE EMBODIMENTS are hereby expressly incorporated into this DESCRIPTION OF EXAMPLE EMBODIMENTS, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It should be understood that while some embodiments of the invention include a wireless network that conforms to the IEEE 802.11 standard, the invention when used in a wireless network is not limited to such contexts and may be utilized in various wireless networks, for example in a network that conforms to a standard other than IEEE 802.11. For example, the invention may be embodied with wireless network interfaces that conform to other standards and for other applications, including other WLAN standards, ZigBee, bluetooth, GSM, PHS, CDMA, and other cellular wireless telephony standards.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

In the description herein, the terms insert, insertable, and inserted are used with respect to the removable computer-readable medium. These terms all cover a method, means or mechanism to couple the removable computer-readable medium to the game-playing device such that program instructions from the first set are readable into the game-playing device. In one embodiment, the coupling is by making physical electrical content. In another embodiment, the coupling is magnetic. Thus in some embodiments, the coupling between the removable computer-readable medium and the game-playing device need not need not be by making physical contact. For example, magnetic and wireless mechanisms are known for data transfer.

The term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

It should also be understood that the logic code, programs, modules, processes, methods, and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, the invention may be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

We claim:

1. An apparatus comprising:
a networkable game-playing device that includes one or more processors, a memory, a media reader in which a removable computer-readable medium is insertable and which is operable to read the contents of a removable computer-readable medium inserted in the media reader, and one or more network interfaces operative to couple the game-playing device to a network;
a removable computer-readable medium with instructions encoded thereon, the removable medium in combination with the game-playing device operative when the removable medium is in the game-playing device to implement a game such that a user can play the game including interacting with the game-playing device, the removable computer-readable medium further including instructions encoded thereon that when executed cause the game-playing device to be recognizable as a controllable playback device via the network, including responding to networked playback commands received via the network such that the game-playing device further operates as a controllable playback device operative to play back digital media,
such that operating the networkable game-playing device as a controllable playback device does not require a user to load playback software into the game-playing device other than inserting the removable medium into the networkable game-playing device.

2. An apparatus as recited in claim 1, wherein the game-playing device includes an optical media reader and wherein the removable computer-readable medium includes an optical medium.

3. An apparatus as recited in claim 2, wherein the optical medium is a CD, a DVD, or an optical game disk.

4. An apparatus as recited in claim 1, wherein the removable computer-readable medium includes a solid-state memory device and wherein the game-playing device includes a memory device interface to the removable solid-state memory device, such that the game-playing device is operative to read data from the solid-state memory device when the solid-state memory device is connected to the game-playing device via the memory device interface.

5. An apparatus as recited in claim 4, wherein the solid-state memory device includes flash memory.

6. An apparatus as recited in claim 4, wherein the solid-state memory device includes a USB device that includes a USB plug, and wherein the memory device interface includes a USB interface including a USB connector operative to accept the USB plug.

7. An apparatus as recited in claim 1, wherein the network interface includes a wired network interface.

8. An apparatus as recited in claim 1, wherein the network interface includes a wireless network interface.

9. An apparatus as recited in claim 1, wherein the game-playing device appears via the network as a controllable playback device after the removable medium is inserted in the game-playing device and the game-playing device is coupled to the network.

10. An apparatus as recited in claim 1, wherein the game playing device is operative as a source of AV content, and wherein the removable computer-readable medium includes programming instructions that when executed by one or more processors of the game-playing device cause the game playing device after the removable medium is inserted in the game-playing device and the game-playing device is coupled to the network to appear as a media server that is operative to provide content to a playback device via the network.

11. An apparatus as recited in claim 1, wherein the game playing device appears via the network as a controllable playback device under the Universal Plug and Play standard called UPnP after the removable medium is in the game-playing device and while the game playing device is coupled to the network.

12. An apparatus as recited in claim 9, wherein the game playing device additionally appears via the network as a media player extender device for Windows XP Media Center Edition.

13. An apparatus as recited in claim 9, wherein the game playing device additionally appears via the network as a media player extender device for a Windows VISTA Windows Media Center.

14. An apparatus as recited in claim 9, wherein the game playing device additionally appears via the network as a media player device for an Apple iTunes Media Server.

15. An apparatus as recited in claim 1, further comprising a remote control device that includes a network interface that is connectable to the network, such that, the game-playing device in combination with the removable computer-readable medium and instructions thereon executed by the one or more processors are operable to cause digital media player functionality in the game-playing device to be recognized by the remote control device as a controllable playback device after the removable medium is inserted in the game playing device and while the game playing device is coupled to the network, such that a user operating the remote control device can remotely operate the game-playing device as a playback device.

16. An apparatus as recited in claim 1, further comprising a remote control device including:
a processor;
a display screen coupled to the processor;
an input device operable to accept user input from a user; and
memory coupled to the processor, the remote control device memory including logic operable when executed by the remote control processor to solicit information from a user, the logic having access to information regarding operation of a plurality of controllable devices that are remote from the apparatus, information regarding content for playback, and information regarding controls available for each respective controllable devices; and the playback capabilities of each controllable device,
wherein the logic in the remote control device memory is further operable when executed by the remote control processor to generate a visual display of a user interface on the remote control display screen that includes set of indications of locations where there are one or more controllable playback devices, such that a user can select one of the different locations for playback using the input device, and further select one or more items of content for playback,
such that as a result of accepting user input a content item for playback at the selected location, and an indication to play back the selected content item, the remote control device causes playback of the content item at the selected location,
wherein the game-playing device is one of the controllable devices, such that the game-playing device in combination with the removable computer-readable medium and instructions thereon executed by the one or more processors are operable to cause digital media player functionality in the game-playing device to be recognized by the remote control device, such that a user operating the remote control device causes the game-playing device to operate as a controllable playback device.

17. An apparatus as recited in claim 16, wherein the user interface on the remote control display screen that includes a set of indications of locations where there are controllable playback devices includes an indication of the current selected location, such a current location is the default location for playback if the user does not change the selected location.

18. An apparatus as recited in claim 16, wherein the logic in the remote control device memory is further operable when executed to access a database of mappings of which controllable playback devices are available at each location.

19. An apparatus as recited in claim 16, wherein the logic in the remote control device memory is further operable to provide for the user a mechanism to select from a set of content items, the mechanism to select enabling selecting only content items that are playable at the one or more selected locations.

20. An apparatus as recited in claim 16, wherein the logic in the remote control device memory is further operable to provide for the user a mechanism to select from a set of content items, and wherein the providing for the user a mechanism to select from a set of content items for playback at a particular location displays a browse location screen that includes content playable at the particular selected location.

21. An apparatus as recited in claim 16, wherein the logic in the remote control device memory is further operable to provide for the user a mechanism to select from a set of content items, and wherein the providing for the user a mechanism to select from a set of content items for playback at a particular selected location includes a mechanism for the user to search for content items playable at the particular selected location.

22. An apparatus as recited in claim 16, wherein the logic in the remote control device memory is further operable to provide for the user a mechanism to select from a set of content items, and wherein the providing for the user a mechanism to select from a set of content items for playback at a particular selected location includes a mechanism for the user to enter text.

23. An apparatus as recited in claim 16, wherein the logic in the remote control device memory is further operable when executed to provide for the user a set of controls for controlling playback of a particular content item as a result of the user selecting the particular content item.

24. An apparatus as recited in claim 23, wherein the providing for the user a set of controls for controlling playback of the particular content item includes providing for the user a subset including content-specific controls, such that the logic in the remote control device memory is operable when executed to combine a set of common user interface items with the user interface elements for the content-specific controls to form a user interface on the remote control display screen for playback of the particular content item, and wherein the user interface for playback of the particular content item depends on one or both of the type of content item and/or the type of controllable playback device for the content item.

25. An apparatus as recited in claim 16, wherein the logic in the remote control device memory further is operable, when executed, to provide a mechanism for the user to enter a user identity, such that the content playable by the user is according to a hierarchical privilege system.

26. An apparatus as recited in claim 16, wherein the logic in the remote control device memory further is operable, when executed, to:
ascertain whether or not a particular selected item of content is directly playable at a particular selected location,
further ascertain, in the case it is ascertained that the data is not directly playable, whether transcoding the data of the particular selected item of content would generate transcoded data that would be playable at the particular selected location; and
in the case it is ascertained that the generated transcoded data would be playable, causing transcoding of the data of the selected media content item to a form playable at the particular selected location.

27. A computer-readable medium with a first set of instructions encoded thereon and with a second set of instructions coded thereon,
wherein the computer-readable medium is a removable computer-readable medium that can be coupled to a networkable game-playing device that includes one or more processors, a memory, at least one network interface operative to couple the game-playing device to a network, and a media reader in which the removable computer-readable medium is insertable and which is operable to read the first set of instructions when the computer-readable medium is inserted in the media reader;
wherein the first set of instructions when executed by the one or more processors cause the game-playing device to be recognizable as a controllable playback device via the network, including responding to networked playback commands received via the network such that the game-playing device further operates as a controllable playback device operative to play back digital media,
wherein the second set of instructions when executed by the one or more processors cause the game-playing device to implement a game such that a user can play the game including interacting with the game-playing device,
such that operating the networkable game-playing device as a controllable playback device does not require a user to load playback software into the game-playing device other then inserting the removable medium into the networkable game-playing device.

28. A computer-readable medium as recited in claim 27, comprising an optical medium, wherein the game-playing device includes an optical medium reader operable to read the optical medium.

29. A computer-readable medium as recited in claim 28, wherein the optical medium is a CD, a DVD or an optical game disk.

30. A computer-readable medium as recited in claim 27, comprising a solid-state memory device, wherein the game-playing device includes a memory device interface to the removable solid-state memory device, such that the game-playing device is operative to read data from the solid-state memory device when the solid-state memory device is connected to the game-playing device via the memory device interface.

31. A computer-readable medium as recited in claim 30, wherein the solid-state memory device includes flash memory.

32. A computer-readable medium as recited in claim 30, wherein the solid-state memory device includes a USB device that includes a USB plug, and wherein the memory device interface includes a USB interface including a USB connector operative to accept the USB plug.

33. A computer-readable medium as recited in claim 27, wherein the network interface includes a wired network interface.

34. A computer-readable medium as recited in claim 27, wherein the network interface includes a wireless network interface.

35. A computer-readable medium as recited in claim 27, wherein the game playing device appears via the network as a controllable playback device when the removable computer-readable medium is in the game-playing device and the game-playing device is coupled to the network.

36. A computer-readable medium as recited in claim 27, wherein the game playing device appears via the network as a controllable playback device under the Universal Plug and Play standard called UPnP. when the removable computer-readable medium is in the game-playing device and the game-playing device is coupled to the network.

37. A computer-readable medium as recited in claim 35, wherein the game playing device additionally appears via the network as a media player extender device for Windows XP Media Center Edition.

38. A computer-readable medium as recited in claim 35, wherein the game playing device additionally appears via the network as a media player extender device for a Windows VISTA Windows Media Center.

39. A computer-readable medium as recited in claim 35, wherein the game playing device additionally appears via the network as a media player device for an Apple iTunes Media Server.

40. A computer-readable medium as recited in claim 27, wherein the game-playing device in combination with the removable computer-readable medium and the first set of instructions thereon executed by the one or more processors are operable to cause the digital media player functionality in the game-playing device to be recognized as a controllable playback device by a remote control device that includes a network interface that is connectable to the network when the removable computer-readable medium is in the game playing device, the game playing device is coupled to the network, and the remote control is coupled to the network, such that a user operating the remote control device can remotely operate the game-playing device as a playback device.

41. A method comprising:
reading program instructions of a first set of instructions from a removable medium with the first set of instructions encoded thereon and with a second set of instructions coded thereon, the reading via a media reader in a networkable game-playing device that includes one or more processors, a memory, one or more network interfaces operative to couple the game-playing device to a network, and the media reader in which the removable computer-readable medium is insertable and which is operable to read the first and the second set of instructions, the second set of instructions when executed by the one or more processors causing the game-playing device to implement a game such that a user can play the game including interacting with the game-playing device; and
executing the read instructions on one or more of the processors of the game-playing device to cause the game-playing device to be recognizable as a controllable playback device via the network.

42. A method as recited in claim 41, wherein the executing of the read instructions causes the game-playing device to be recognizable as a controllable playback device in a UPnP domain.

43. A method as recited in claim 41, further comprising:
receiving one or more playback commands via the network; and
playing back content according to the one or more playback commands.

44. A method as recited in claim 41, wherein the executing of the read instructions causes the game-playing device to be recognizable as a controllable playback device in a UPnP domain, the method further comprising:
receiving one or more playback commands from a UPnP via the network; and
playing back content according to the one or more playback commands.
